(19) United States
(12) Patent Application Publication
(10) Pub. No.: US 2003/0225477 A1
(43) Pub. Date: Dec. 4, 2003

(54) Modular equipment apparatus and method for handling labware

(76) Inventors: Tom Gilman, Newhall, CA (US); Philip J. Farrelly, Short Hills, NJ (US); Clifford A. Olson, Granada Hills, CA (US); Lajos Nyiradi, Bedminster, NJ (US)

Correspondence Address: CISLO & THOMAS, LLP, 233 WILSHIRE BLVD, SUITE 900, SANTA MONICA, CA, 90401-1211, US

(21) Appl. No.: 10/353,099

(22) Filed: Jan. 27, 2003

Related U.S. Application Data
(60) Provisional application No. 60/365,414, filed on Mar. 19, 2002.

(51) Int. Cl. G06F 7/00

(52) U.S. Cl. 700/214

(57) ABSTRACT

This invention discloses a system and method useful in moving labware between laboratory devices, such as liquid handlers, readers, washers, dispensers, sealers, incubators, microarrayers and labeling devices, such a bar code labelers, to aid in automation of laboratory tasks and assay procedures. Work cells addressing particular laboratory tasks comprise modular components such as stack links, track links, arm links and laboratory devices, such as washers or plate readers. Based upon the required flow of labware movement, the individual modular components are selected and interconnected to create a high-speed work cell. The work cells are easy to configure and setup and permit configuration on available bench top space or within other small spaces, such as laboratory fume hoods. All mechanical and electrical connections between the module components of the work cell are self-contained within the system. A mechanically robust and simple design of the work cell configuration permits reliable walk away automation.

### RELATED APPLICATIONS

This application claims priority from the related provisional patent application for Modular Equipment Apparatus and Method for Handling Labware, filed on Jan. 27, 2002, which is hereby incorporated in its reference in its entirety.

### BACKGROUND OF THE INVENTION

1. Field of the Invention

This invention relates to automated labware handling systems and methods.

2. Description of the Related Art

Laboratory automation is a term that is used to describe the application of automation and robotics for processes used in scientific labs to improve the quality, efficiency, and relevance of laboratory analysis. Lab automation does not encompass a single function or process. A wide variety of products and processes are used within the lab automation environment. The image that frequently comes to mind when discussing robotic automation is a robot that is accomplishing some type of manufacturing process in place of a human. While robots are indeed an important part of the lab automation environment, there are many other facets that also play important roles. There are also some significant differences between the application of industrial robots that have been used in manufacturing and the special requirements of the laboratory.

Industrial automation, the application of using some type of machinery to replace humans for routine, repetitive tasks, has been applied since the early 20th century. However, robots capable of performing relatively complex tasks were not developed until the 1950's and were not routinely applied until the mid-to-late 1970's. Industrial automation is thus fairly new, but is being used at an ever-increasing rate. Lab automation is even newer, dating back to the early 1990's. The history of lab automation parallels the development of modern drug discovery within the pharmaceutical industry. Modern drug discovery is intimately dovetailed with the development of the microtiter plate. The microtiter plate, which today is also commonly referred to as the microplate (and sometimes, simply “plate”), was originally developed in the 1950's, with advances such as molding developing over the next several decades. The 96-well microplate format was applied to scientific assays such as ELISA's in the 1970's, and has become a ubiquitous tool since.

Experiments such as biological assays that required the addition of various reagents and buffers had previously been done primarily in some type of tube-based format. The microplate provided a simple platform that could be used to perform experiments on large numbers of samples, while using less consumables and equipment. Its original commonly used format of 96 wells, arranged in 8 rows of 12 wells, provided a much more convenient way to perform experiments on that number of samples compared to working with the same number of tubes. A new advancement in the research and development of new drugs was also being developed at about the same time that the microplate format started to be used. High throughput screening, or HTS, was being developed to search large numbers of potential drug candidates for activity against a specific disease. These drug candidates may be molecules that have been derived from natural sources, such as plants or sea sponges, or they may be small molecule libraries that have been built up by organic chemistry. Using another newly developed process known as combinatorial chemistry, basic molecular building blocks are combined together to create large numbers of unique molecules.

Whether these potential drugs are derived from natural sources or by combinatorial chemistry, they form compound libraries, which become the intellectual property of each drug company. These compound libraries range in size from 10,000 to 10,000,000 different compounds. Any specific compound within the library could be the one that will be active against a specific disease state, and the trick is to find that one. The HTS process is designed to do just that. The “screening” part of HTS is the actual test being done. There is no one “screen”; instead, there are a variety of different assays that are performed, dictated by the type of molecule, or reaction, being studied. The screens can be immunoassays, enzyme reactions, cell-based assays, and any of a number other specialized tests. Assays are chosen, and optimized, based on the specific disease or target molecule being studied. The “High Throughput” part of HTS implies that large numbers of compounds can be screened using these assays in as short a time period as possible. Prior to HTS, it was common to think in terms of analyzing 100 samples per day. But if you need to search through a library of 100,000 compounds, this means 1,000 days, or more than three years of work, to search the entire library, a time period that is plainly too long. HTS is commonly defined as the analysis of 10,000 samples per day. The microplate provides a way to make this possible. In its original format of 96 wells, if all 96 can be simultaneously analyzed, this means that only 100 plates per day need to be processed, a less daunting number than 10,000 individual samples. The reality of the numbers involved is more complex than the previous simple example. Each well is not analyzed on its own as a single complete experiment. Instead, there is “overhead” involved in the form of additional individual tests that need to be done for each assay. Typically, a series of standards of various concentrations need to be analyzed in order to properly determine an accurate result, and each sample itself may be analyzed in varying concentrations. Furthermore, there may be replicate runs for each sample in the form of duplicates or triplicates in order to increase confidence in a positive result. Taking all of these factors into account, it all adds up to a lot of individual analyses that need to be performed.

When any given compound in the library produces a positive result in the assay, this is considered to be a “hit”. The hit indicates a potential drug compound that could be developed to help treat the targeted disease, or target. The key word is “potential”, because there is much further detailed study that needs to be performed on a hit to determine if it will really be useful. For example, it may be possible that a given compound will effectively target the desired disease molecule, but at the same time, cause further illness or even death in the patient. Obviously, this is not a viable drug. Hits drive further study for possible useful drugs, and HTS is the beginning of the cycle to produce these hits. Depending on the specific experiment being done and the assays involved, any given HTS screen might product a few hits, many hits, or even no hits. The art and science of drug discovery is used to fine tune this process and drive HTS toward the final goal of a viable drug. With this basic understanding of drug discovery and HTS, the evolution of lab automation is more easily understood.

In order to effectively exploit the microplate format, a primary requirement is to develop a way to automate the filling of the individual wells with whatever liquid is required. To accomplish this, the first lab automation devices to be developed were pipetting workstations. These workstations automated the tedious task of pipetting, previously performed manually using handheld pipetting dispensers. It is not difficult to see that pipetting in this manner into the 96 wells of a microplate, and then repeating the process for 100 plates, would be a tedious task. In fact, there are some significant drawbacks to such an operation such as the potential for human errors, hazardous material contamination risk, and a risk of repetitive motion stress injury.

Out of this need arose the pipetting workstation, also referred to as a liquid handling workstation or simply liquid handler. These systems use mechanics to perform the same pipetting operations as handheld pipettors. They also use some type of positioning mechanism so the pipetting tips can be moved between the source of the liquids to be dispensed and the wells of the microplate. Liquid handlers remain the cornerstone of lab automation. Again, as will be a recurring theme whenever describing lab automation, there are many different ways that can accomplish the task. Liquid handlers can be based on a vacuum-based delivery system or a positive-displacement syringe-driven system. Newer low-volume systems are based on piezo-electric or ink-jet technologies. Needles/probes or disposable tips may be used to for the delivery mechanism. These delivery tips may be a single probe that is rapidly moved among the well positions, a set of 8 tips that can simultaneously pipette to an entire row, or even a set of 96 that can pipette to an entire 96-well plate at once. The liquid handlers can either deliver liquid to the plate or aspirate liquid out, as is required by the multiple-step nature of the assays. The development of the liquid handlers established that automation of assays could be achieved using the microplate format. It became possible to set up a system to do a variety of pipetting steps on a large number of individual samples without human intervention.

Each assay is measured for success by taking a reading for a positive result. The variety of assays that are used produce results that require a variety of reading, or detection, technologies. These include absorbance, fluorescence, chemiluminescence, bioluminescence, and radioactivity. “Pre-lab automation” detection systems used a traditional tube (or cuvette) based “one-at-a-time” method of data analysis. Performing an automated assay in 96 wells of a microplate and then having to move each well one at a time into a tube for detection is obviously not a viable solution for high throughput. To meet this need, vendors began introducing “microplate-readers” of all types, providing the critical capability of reading directly in the same microplate that the assay was performed in.

The microplate format triggered the introduction of a variety of devices that could become part of an HTS assay, all based on working within the same microplate format. For example:

Washers were developed for the sole function of rapidly rinsing the plate with the buffers or reagents that must be applied evenly across all of the wells. These washers specialize in this task, and can do it more quickly and efficiently than liquid handlers; Dispensers can perform bulk pipetting more quickly than liquid handlers and with better accuracy than washers;

Sealers automate the sealing of microplates with a protective layer;

Bar code labelers apply bar code labels to microplates;

Incubators provide the temperature and humidity environment required by many assays; and Autosamplers inject samples from microplates into analytical instruments for performing tasks such as high performance liquid chromatography (HPLC) and gas chromatography/mass spectrometry (GC/MS).

The development of these microplate-based devices initiated the concept of lab automation. Now, a lab could process thousands of samples a day. However, there were still many manual steps that were involved. Liquid handlers have limited capacities for microplates. They may be able to process 6-20 plates, after which these plates need to be removed and new ones added. Typically, these plates were manually carried to the next microplate device, such as a washer, and eventually to a reader. This manual “sneaker-net” of plates was much better than working with tubes, but the newly developing HTS specialists yearned for more complete automation. Since robots, specifically robotic arms, were already being extensively used in industrial applications, the first concepts were derived by studying those. The idea was to have an articulating robotic arm take the place of the human operator by picking up plates and moving them from one device to the other. Thus, the first fully automated lab automation systems were developed. The unique competencies required to builds such systems brought together the types of people that make up HTS groups today: Not only scientists, but also engineers with experience in robotic applications and software programmers.

The first fully automated lab automation systems were built using commercially available articulating robot arms to move the plates between the various devices required for the assay. The arm was typically installed on a linear rail to provide further movement among the components. These systems also became commercially available, with some vendors specializing in putting together fully automated systems based on linear-track-driven articulating arm systems. The large-scale track-based robot systems were used to further advance lab automation by removing more and more of the requirement for human intervention in order to complete as assay. Large pharmaceutical companies in particular led the way in the installation of these large-scale systems. These large-scale systems while powerful, did suffer from some limitations, in particular with respect to device integration/communication issues, complexity, inflexibility, long implementation timeframes, and large investment commitments.

No single vendor makes all of the various microplate-based devices that provide the menu to select from for a given assay. By nature, each device has its own methodology of programming, operation, and communication. There can be difficulty in getting a smoothly functioning system built from the various components that are desired. While powerful, many of these systems are complex both in terms of their initial design and in their daily operation. The large-scale systems can be installed to be highly effective in the execution of a specified assay, but it is often difficult as well as prohibitively expensive to reconfigure them for a different assay. Thus, it is not unusual to see a 6-12 month time period between the time of the initial order of the system and the time it becomes fully operational. These systems can be very expensive to implement, costing from $150,000 to over $1,000,000. As the Lab Automation market matured, some vendors developed tools to address some of these shortcomings, such as common programming languages or communications protocols to improve the communication among different devices within a system. But even today, these limitations still apply.

In response to the limitations of the large, linear-track, articulating-arm lab automation systems many users began to build smaller “workcells” that address the shortcomings of the larger systems. This is not to say there is no longer a place for the large-scale systems. They will continue to be an important tool in the continual development and improvement of Lab Automation processes. The smaller Workcells are now expanding as a new tool that can supplement these systems.

A workcell can be thought of as a small, automated solution that addresses a single task such as reading plates, or some portion of an assay. Workcells can be based on stackers or cylindrical robot arms. A workcell may consist of a single automated device, or several. An advanced workcell may be capable of performing most or even all steps for an assay. In most cases, these systems won't process a given batch of microplates more quickly than it is possible for a focused human to do it, which is to say that the “throughput” will be about the same. The “throughput” defines the speed of operation at hand. For example, if a given solution can process 60 microplates in 10 hours, then its throughput is 6 plates per hour, or 1 plate per 10 minutes. While throughput is important in order to maximize the number of individual samples that can be screened in a given time period, of major importance in Lab Automation is “walkaway automation”. This simply refers to the ability to load a large number if microplates, start the system, and come back later to pick up the processed plates. Using walkaway automation addresses all of the shortcomings of using humans such as human error due to fatigue and boredom. Of course, a single robot can be programmed to operate 24 hours a day, 7 days a week, but as is the case with automation in other areas of industry, the end result is an improvement in the labor force. Other more interesting job functions can be performed, and job security is certainly preserved, as someone will always be needed to run and maintain the automated systems. Certain high-capacity, high-throughput operations such as those found in production environments require more speed and capacity than the workcell concept can deliver. These requirements can be met with custom-designed and built systems, but these are expensive and require long lead-time.

### SUMMARY OF THE INVENTION

The present invention is a system that provides the capability to easily build a high-speed labware movement system by selecting from a menu of components. The system is based on a modular, high-speed conveyor system that is connected to stackers and other lab automation devices. Microplates, deepwell plates, tip racks, and microtubes are shuttled between devices via the conveyor. Labware can be removed from the conveyor and placed on an outlying device by fast pick-and-place robot arms. The present invention provides an easy way to build a high-speed, high-capacity lab automation workcell that is configured for the task at hand. Because of its modular design, it can easily be expanded or reconfigured for different operations.

The basic components of the system are labware stackers, conveyor sections, and pick and place robots, and a control circuit. For example, an embodiment of the present invention includes a stacker, having a mechanism for pickup and release of said labware for storage, a plurality of interchangeable conveyor sections having mechanical and electrical interface connections for allowing bi-directional movement of labware between a plurality of locations on the handling system a robotic positioning device for placing or removing objects on from said modular conveyor sections and a programmable circuit for dynamic scheduling of automatic lab ware handling operations.

These components are used to configure the desired workcell. The robotic arms provide rapid movement of the labware from the conveyor to the nest of a microplate-based device such as a reader or washer. Alternative embodiments will allow direct incorporation of third party designs into the system, producing even simpler and faster configurations. For example, a plate washer's nest could be directly integrated with a conveyor, allowing plates to rapidly be moved into and out of position for washing. Other embodiments can be configured around liquid handlers as well. The labware can be moved directly across a liquid handler deck, and additional devices from any vendor can added to the system to create a more powerful workstation. For example, a liquid handler that is expanded with a stacker, a reader and a washer.

The system can be programmed to communicate by serial commands, dynamic data exchange (DDE), ActiveX, small computer system interface (SCSI), or relay control, and possesses the ability to develop functioning interfaces within reasonable timeframes and costs. More than 80 lab automation integrations that have been developed by Hudson will be available for SoftLinx. These include laboratory automation devices that have been integrated by Hudson Control Group and/or third parties. The laboratory automation devices include advanced liquid handling systems (e.g. Beckman Coulter Biomek®2000); pipetting stations and basic liquid handling systems (e.g. Beckman Coulter Multimek™/Multipette), dispensers (e.g. Bio-Tek® Microfill AF 1000; Washers (e.g. Bio-Tek® E403/404); sealers (e.g. Abgene™ ALPS 300 Plate Sealer); incubators/freezers/storage devices (e.g. Jouan Robotics MolBank™; mass spectrometers (e.g. Micromass™ MUX); thermal cyclers (e.g. MJ Research™ PTC Series); plate readers/imaging systems (e.g. Amersham Biosciences LEADseeker™); bar code labelers/readers (e.g. Beckman Coulter Sagian™ Print & Apply and microarray spotters (e.g. the Radius 3XVP™ Arrayer). Another alternative embodiment of the present invention includes a simple-to-use graphical interface and a drag-and-drop method editor. The system may also include built-in multitasking to manage multiple tasks and achieve optimal throughputs. The system may include a multitasking executable core program built for controlling lab automation workcells. A Visual Basic for Applications (VBA) Script controls each device, or interface, that is installed in the software. This allows a user or system integrator to rapidly develop device interfaces for users that want to install a functional workcell with a simple interface. Additionally, these scripts are open for users with programming experience who wish to have the capability to modify the interfaces, or even entirely create their own interfaces.

### BRIEF DESCRIPTION OF THE DRAWINGS

FIG. 1 is a side view of a work cell comprising a stack link, washer, liquid handler, reader and incubator.

FIG. 2a is a side view of a work cell comprising a single stack link and a liquid handler.

FIG. 2b is a side view a work cell comprising two stack links for mother and daughter sets of laboratory plates, and a liquid handler.

FIG. 3 is a flowchart of the SoftLinx software to integrate the work cell and laboratory devices.

FIG. 4 is a flowchart of SoftLinx integration with third-party laboratory devices and operating software.

FIG. 5 is a side view of a work cell comprising an arm link and two stack links connected by a drive link and track links.

FIG. 6 is a side view of a work cell comprising an incubator, stack link, arm link, washer, liquid handler and reader.

FIG. 7a is a side perspective view of a stack link.

FIG. 7b is a side perspective view of a drive link.

FIG. 7c is a side perspective view of a track link.

FIG. 7d is a side perspective view of an arm link.

FIG. 8a is a top view of a work cell comprising a stack link, stop link, track link, drive links and an arm link.

FIG. 8b is side view of a work cell comprising a stack link, stop link, track link, drive links and an arm link.

FIG. 9 is a side perspective view of a work cell comprising a stack link, stop link, track link, drive links and an arm link.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The system of the present invention is based on a modular, high-speed conveyor system that is connected to basic system components, such as stackers or stack links, and to other lab automation devices. The present invention provides an easy way to build a high-speed, high-capacity lab automation workcell that is configured for the task at hand. Because of its modular design, it can easily be expanded or reconfigured for different operations.

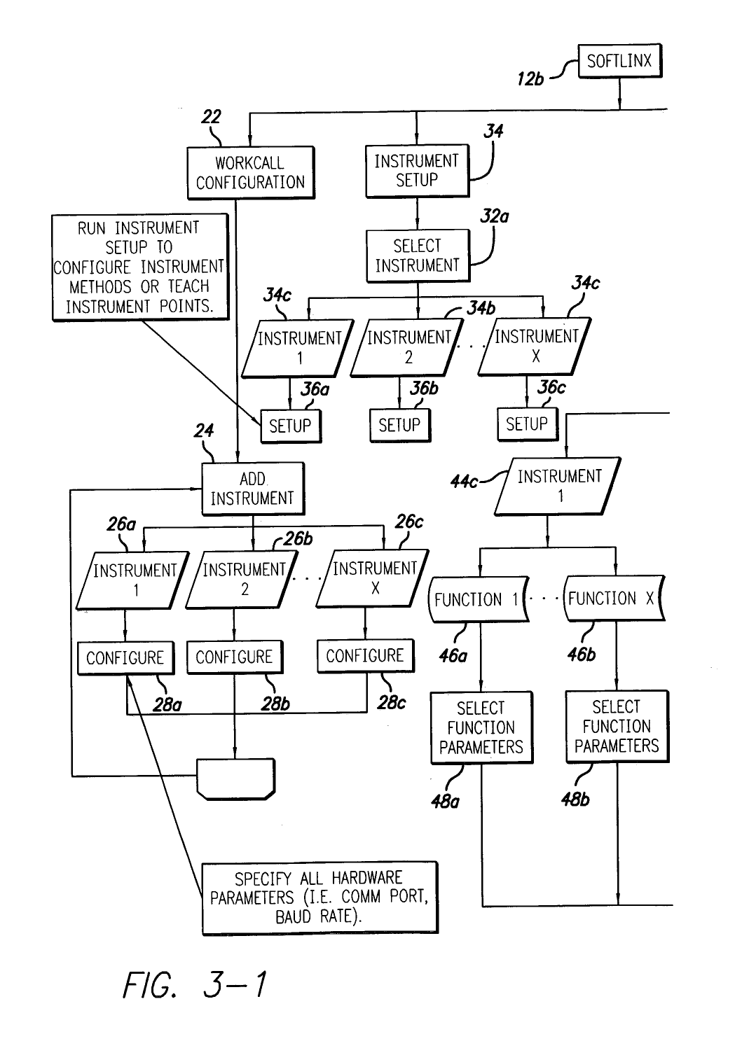

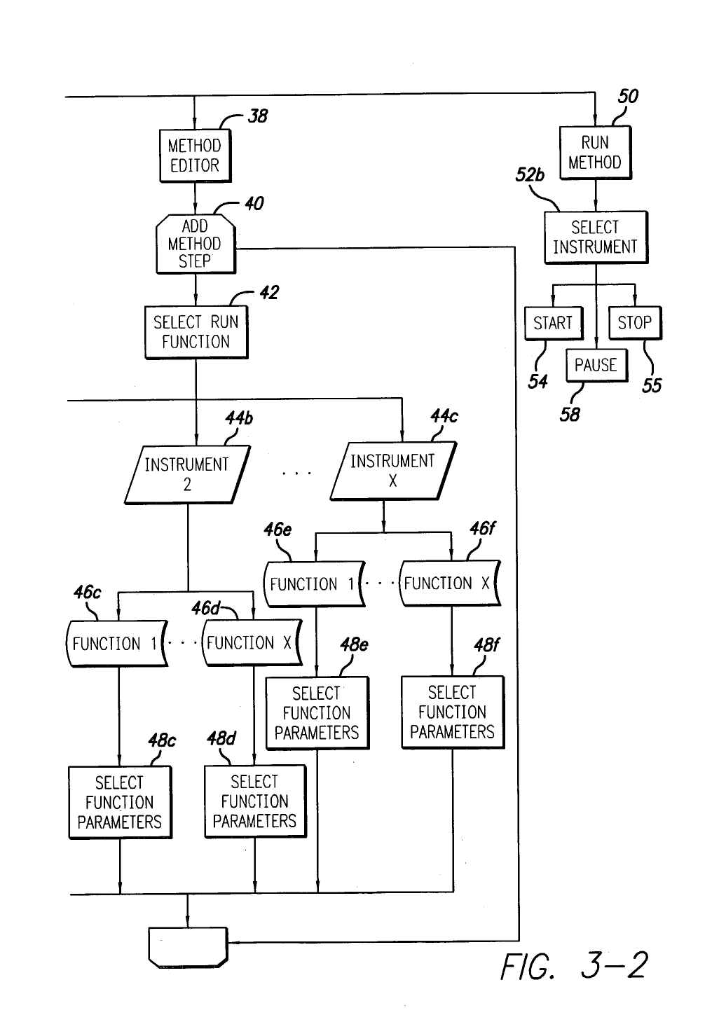

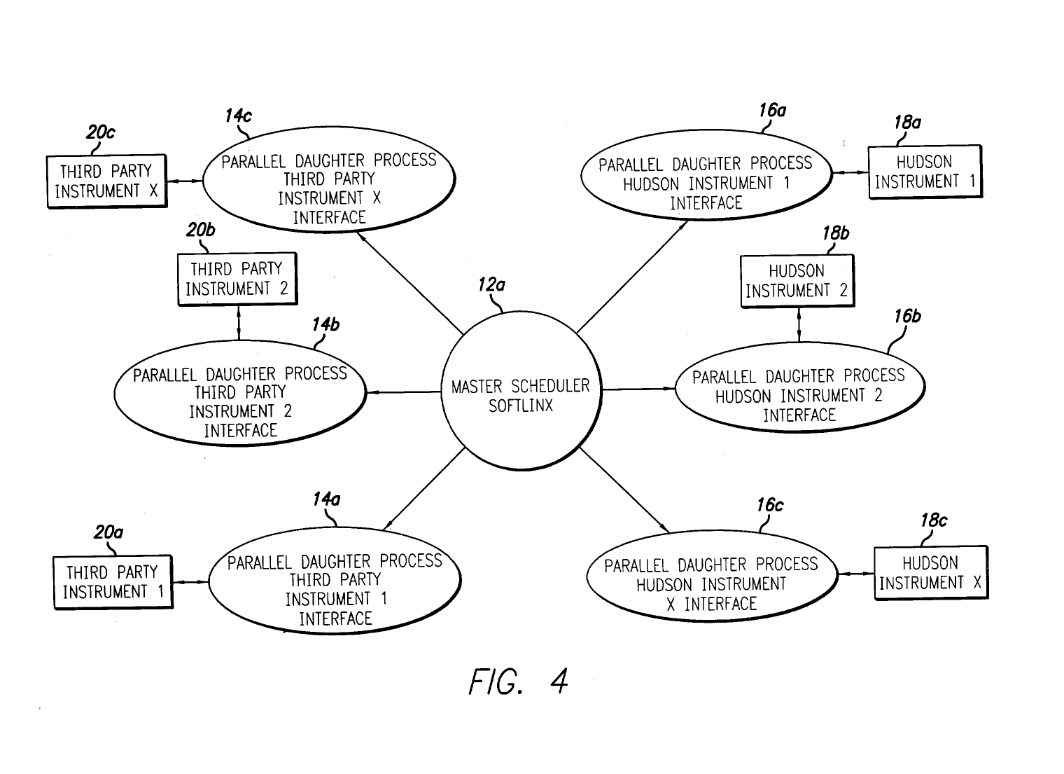

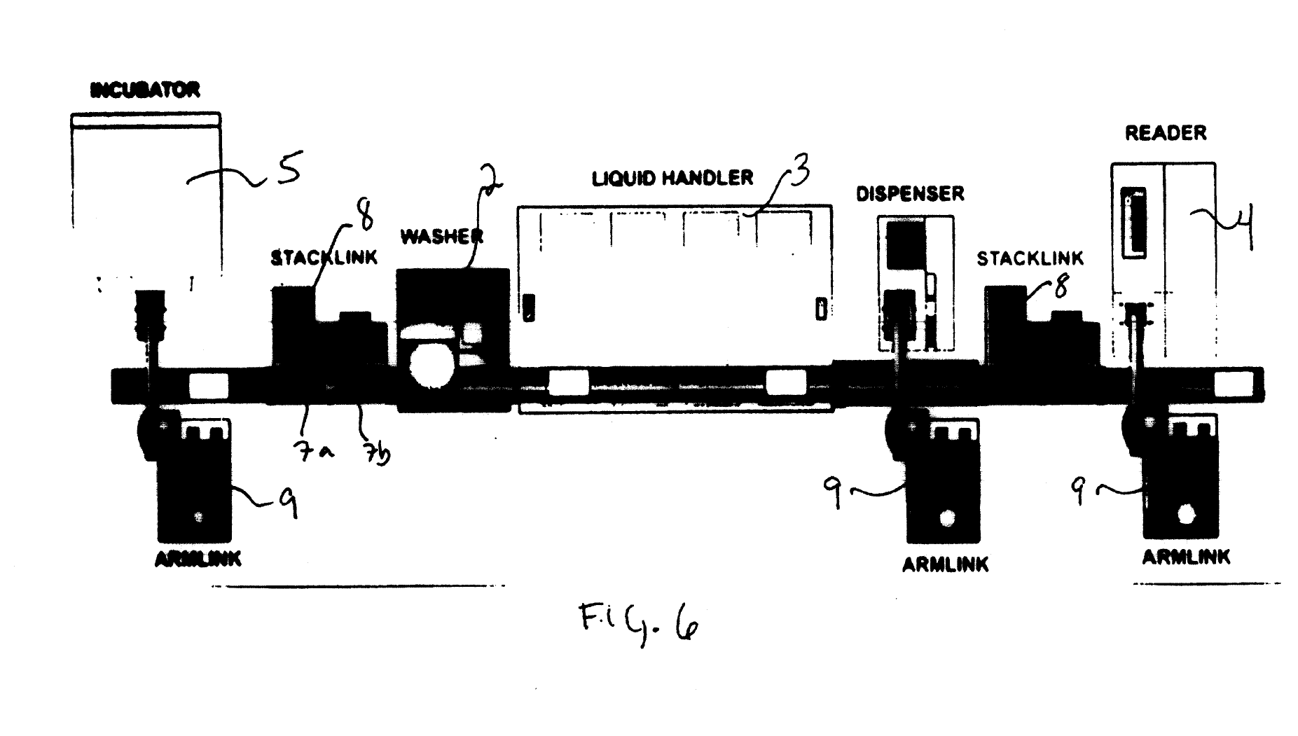

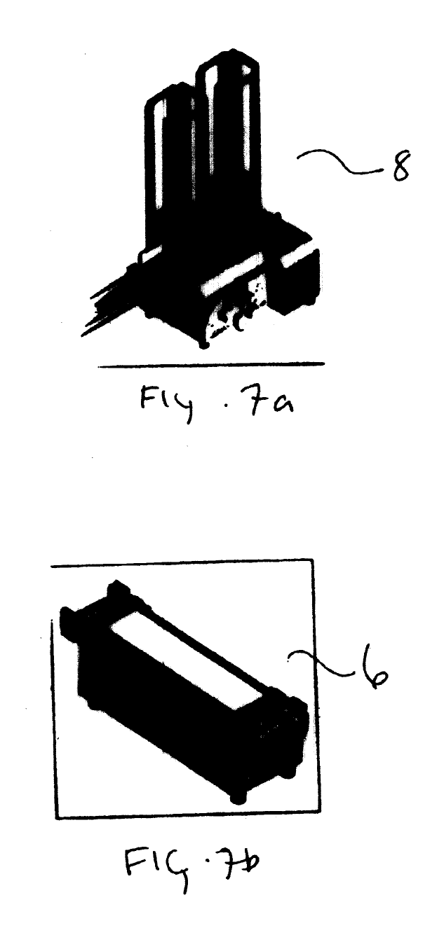

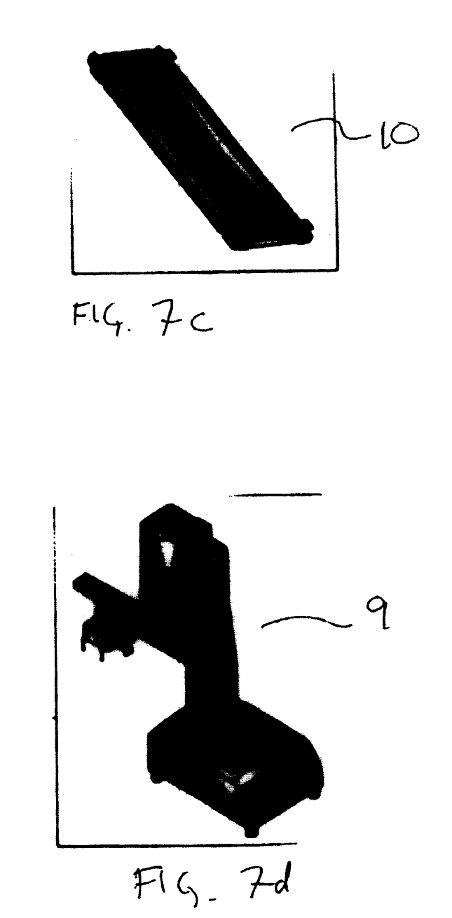

The basic components of the system are labware stackers 8 (FIG. 7a) or ‘stack links’, conveyor sections 6 or ‘drive links’ (FIG. 7b), and pick and place robots 9 (FIG. 7d), modular conveyor extensions or ‘track links’10 (FIG. 7c) to configure the workcell for bi-directional movement, and a control circuit (see e.g. FIGS. 3-4). For example, an embodiment of the present invention includes a stack link 8 integrated with a mechanism for pickup and release of labware for storage, a plurality of interchangeable drive link sections 6 having mechanical and electrical interface connections for allowing bi-directional movement of labware between a plurality of locations on the handling system, a robotic positioning device 9 for placing on or removing objects from the modular drive link sections 6, and a programmable circuit for dynamic scheduling (see e.g. FIGS. 3-4) of automatic lab ware handling operations.

In a first example, Example I, a commercially available washer 2, such as the Techan PW384198 Washer is integrated with certain components of the instant invention to automate plate washing of a batch of laboratory plates 1, or similar. The washer 2 may be a flexible washer for 96- or 384- well plates that is suitable for ELISA or cell washing. Integration of components of the instant invention with commercially available washers may be used to expand the capacity, throughput and connectivity to additional laboratory automation devices. For the system of Example I, the basic components include a plate washer 2 or similar device, a stack link 8, and computer hardware and software for running SoftLinx and additional software, such as Tecan WinWash Plus™ software for dynamic scheduling of washing and handling operations. Optional modules such as interchangeable conveyor sections or track links 6 and robotic positioning devices may be added to expand the system of Example I.

A basic workcell layout for Example I is created by combining a stack link 8 with the washing device 2 in order to provide walk-away automation for a batch of plates 1 and permits processing of as many as sixty (60) microplates. The washing device 2 may be modified to integrate directly with a track in the stack link 8, eliminating the need for adding a robotic arm to move the plates, or other items to be washed, back and forth to the washing device 2. In this Example, the stack link 8 comprises a first stack 7a that is used for plates to be washed and a second stack 7b that is used to store processed plates. Additional stack links 8 may be daisy-chained with the stack link 8 of Example I if greater capacity is desired for a particular application. Likewise, additional laboratory devices may be added to the system to perform multiple tasks or to incorporate the washing device into a complete assay system. In Example I, the stack link 8 delivers a microplate or similar to the washing device 2 within 2-10 seconds, which is more efficient than performing the same task using a typical robotic arm device. Where additional laboratory device are connected to the system of Example I, throughput may be increased further by performing individual operations in parallel using a built-in dynamic scheduling capability provided by, for example, the SoftLinx software. For example, a set of two stack links 8 may be integrated with the washer 2 for washing 180 plates, or the system of Example I may be integrated with a plate sealer or similar device to create a multifunction workcell. In operation, the user may simply load sixty (60) plates or more into a stack, place the stack on the stack link and start the system. The system will feed plates from the stack input to the washer, activate the washer and return the plates to the output stack. The process time may vary depending upon the washer cycle time, but the system may be configured so that the operator is free to leave the system unattended to perform other laboratory tasks. The modular work cell system of Example I may be controlled by lab automation software, such as Hudson Control's SoftLinx (see FIG. 3), which includes a multitasking core executable combined with device interfaces that are written in Visual Basic for Applications (“VBA”). The user sets up a method using a drag-and-drop icon based method editor and the software interface for the washing device may communicate via the OLE protocol. The interface permits the user to select any method that is in the software of the washing device that is running on the same computer.

In a second example, Example II, the instant invention is used to create a work cell comprising a commercially available liquid handler, such as for example, the Sias Xantus™. The dispensing and aspirating functions of liquid handlers are generally used to perform solvent/reagent additions, dilutions, plate replications and consolidation of other microplate-based tasks. Commercially available liquid handlers may also comprise decks with large labware capacities, but not adequate for extended processing of large numbers of plates. Further, where disposable components, such as pipette tips, are being used the tip supply can limit be a limiting factor that makes walk-away automation of the system difficult or impossible. In Example II, system components of the instant invention are integrated with the liquid handler to provide a steady supply of labware to the liquid handler. The liquid handler used may be large enough to allow integration of multiple microplates or other devices such as shakers, washers or readers. The instant invention may also be integrated with other types of liquid handlers, including handlers comprising single or dual arm robotic liquid handlers, such as for example, liquid handlers comprising sixteen (16) pipetting tips or a 270° robotic gripper. Where the liquid handler is integrated with other devices, further storage capacity for the microplates may be added to provide longer “walk-away” automation times.

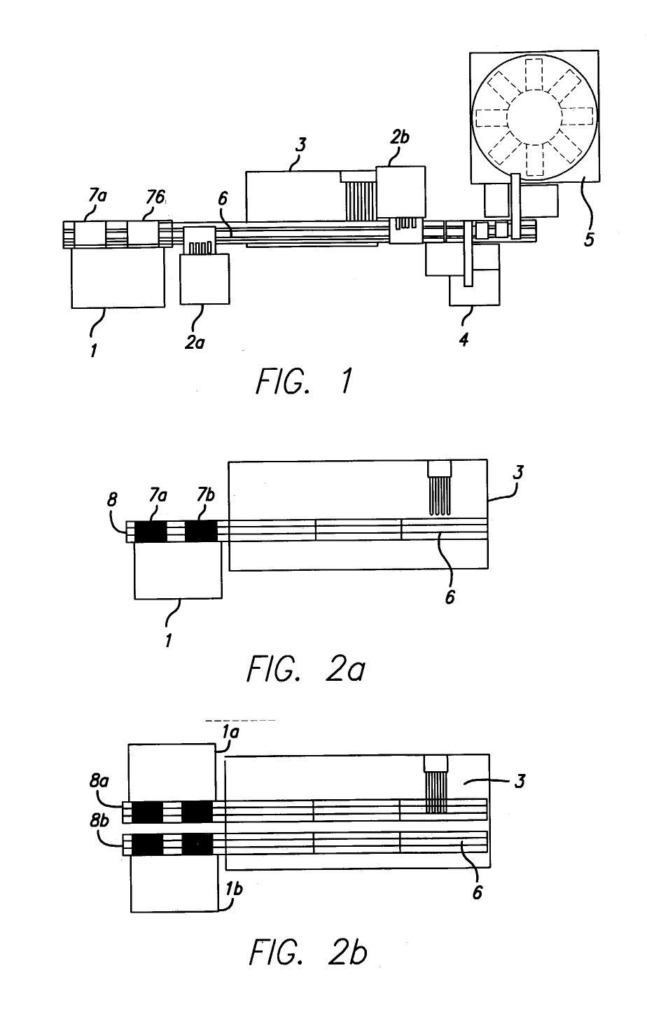

In Example II, the instant invention may be configured to provide a supply of microplates to the liquid handler for dilutions, reformatting, replication and other pipetting functions. The liquid handler may be configured with a single stack link to process up to sixty (60) microplates. The plates will move from an “IN” position to the liquid handler and will be subsequently delivered to an “OUT” position on the stack link 8 (FIG. 2a). A drive link 6 for transporting the plates 1 and an arm link 9 for moving the plate from the drive link conveyor 6 to another laboratory device, such as a reader 4, may also be added.

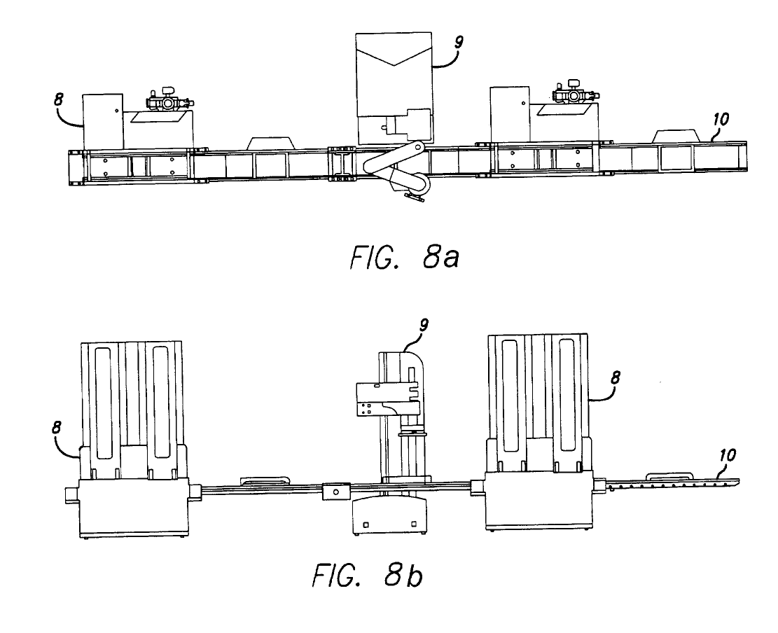

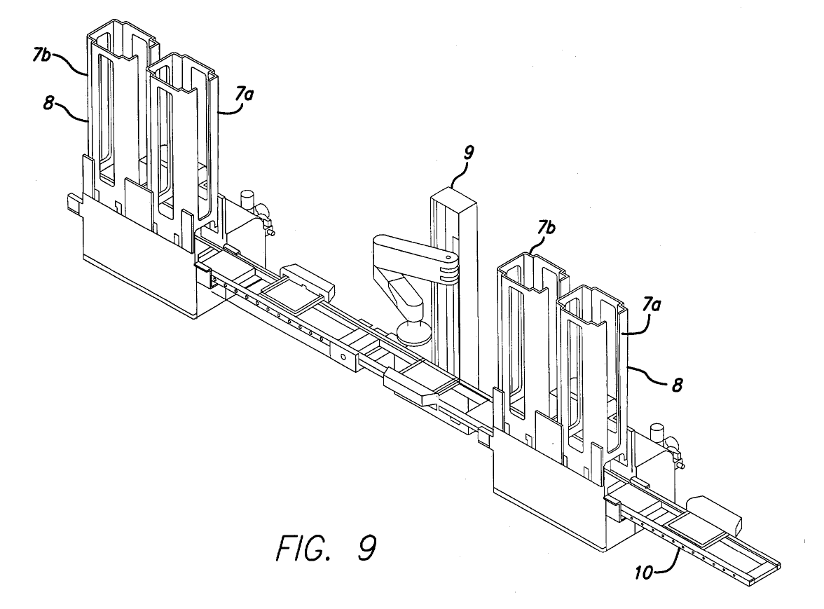

In a first step, the single stack link 8 is configured adjacent the liquid handler 3 and delivers plates 1 to a deck on a drive link 6. The instant invention permits accurate positioning of the plates 1 so that direct pipetting is permitted to 96- or 384-well format plates while on the track link 10 or drive link 6. This feature increases the throughput of the workcell because the plate does not need to be removed from the drive link 6 or track link 10 by, for example, a robotic arm. Additional stack links 8 and drive links 6 or track links 10 may be added to the configuration of Example II so that two or more plates 1 may be delivered in succession to two or more stop positions on the deck of the drive link 6 conveyor as is shown in FIGS. 8-9. With this configuration, up to sixty (60) mother plates 1a and sixty (60) daughter plates 1b can be supplied to the liquid handler 3.

In Example II, two (2) plates may be delivered to the liquid handler 3, where they may be accessed directly by the pipetting tips. If desired, an arm on the liquid handler may be used to move the plates to a holding position or storage area. The capacity of the work cell of Example II may be expanded by adding additional stack links 8 to the work cell. The additional stack links may be used to increase an overall supply of plates or to increase throughput. Likewise, individual stack link modules may be designated to deliver different types of plates, such as mother plates and destination plates. Stack links may also be configured on either side of a deck on the liquid handler. In this case the lab link track link 10 or drive link 6 is configured completely across the deck of the liquid handler to allow plates to mover from one side to the other, stopping at multiple positions in-between. This configuration increases the throughput of the work cell since plates may be stored or transferred after processing while new plates are being delivered. Additional devices may also be added to the configuration of Example II. For example, washers, dispensers, readers or other microplate-compatible automation devices may be added, or to provide for post-processing functions such as plate sealing. For example, the liquid handler may be integrated using the instant invention to a washer and reader where the washer is an ‘online’ device. In this configuration, the plates are delivered directly to a wash head on the washing device without leaving the track link 10 or drive link 6 conveyor.

The work cell components of Example II are mechanically integrated for stability using standard mechanical mounting devices known in the art, such as for example, bolts or interfacing snap elements. The liquid handler of the work cell may be programmed by way of suitable software, such as in this example, X-AP software from Sias, which includes DECKMATE for ‘drag and drop’ arrangement of the liquid handler work space and a scheduling protocol editor. Work cell software, such as SoftLinx software that may feature a ‘drag-and-drop’ method editor and operates the system via event-driven dynamic scheduling, is then used to program the work cell modular components and to perform supervisory control over the entire system, including the liquid handler and any other devices included in the work cell (see e.g. FIG. 4). The liquid handler software and the work cell software will run concurrently on the same computer. The liquid handler and any additional laboratory automation devices, may be controlled via a serial cable. A serial expansion accessory may be added to the computer in order to provide additional serial ports.

In a third example, the washer work cell of Example I and the liquid handler workcell of Example II may be integrated together to build ad system that will automate the washing and liquid handling of a series of laboratory plates. For example, the system may provide up to sixty (60) plates to the washer, then to the liquid handler and transport the plates back to the output stack of a stack link. The capacity of any configuration may be increased by adding additional stack links as desired for a particular application. Each stack link preferably has two stacks that are independently addressable. Where one stack link is used, a first stack in the stack link will be the “input” position where the plates to be processed will initially be loaded. The processed plates are returned to a second stack in the stack link that is the “output” position. Where the system is configured with two stack links, then both stacks in one of the stack links may be used as the input position and both of the stacks in the second stack link may be used as the output position to permit a total capacity of 120 standard microplates.

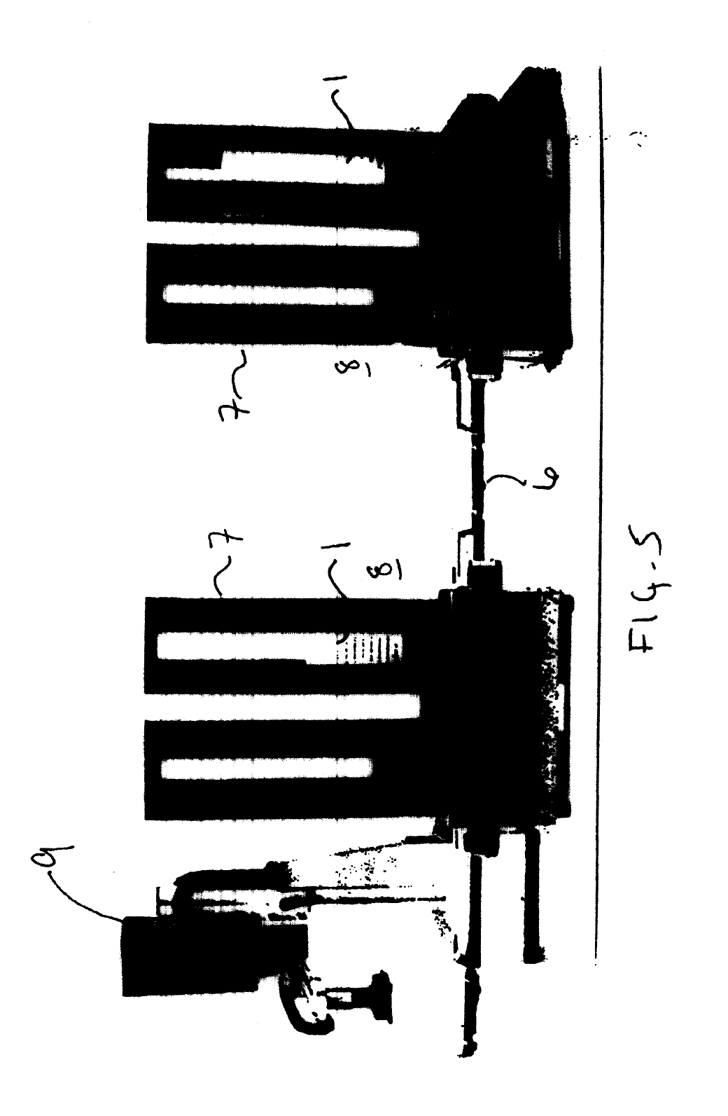

In a fourth example, components of the instant invention are integrated with reading/imaging systems, as is shown in FIG. 6. Many microplate-based devices such as reading and imaging systems do not have physical designs that allow track-based feeding of laboratory plates. The reading and imaging systems may be integrated into a work cell by using an arm link 9 that moves a plate from a first fixed location to a second fixed location (FIGS. 5-6). The arm link 9 may be configured to move objects within a single axis or may be used to pick up an object from, for example a drive link 6 or track link 10, rotate it ninety (90) degrees, and place the object on a perpendicular drive link 6 or track link 10. The arm link 9 may also serve to integrate the reading or imaging device with additional laboratory devices to allow automation of multiple assay steps or complete single temperature assays, as is shown in FIG. 6. For example, a plate reader 4 may be integrated into a work cell using an arm link 9 to move laboratory plates 1 from additional laboratory devices, such as washers 2 or liquid handlers 3, to a drive link 6 to the reader 4 and back. Bi-directional control of the plate movement may be used to bring the plates back to the liquid handler 3 for additional reagent dispensing steps or to the washer for additional washes. The arm link 9 may also be integrated into a work cell comprising an incubator 5 or freezer or similar laboratory device as shown in FIG. 1. The arm link may be used to move laboratory plates from the rest of the work cell to the incubator 5 or freezer. For example, after initial liquid handling, the plate may be placed in the incubator 5 or freezer for a specified time and then brought out of the incubator 5 or freezer and transported to the reader 4 or imaging device.

While the present invention has been described with regards to particular embodiments, it is recognized that additional variations of the present invention may be devised without departing from the inventive concept.

What is claimed is:

1. An automatic labware handling system, comprising:
a stacker having a mechanism for pickup and release of said labware for storage;
a plurality of interchangeable conveyor sections having mechanical and electrical interface connections for allowing bi-directional movement of labware between a plurality of locations on the handling system;
a robotic positioning device for placing or removing objects on from said modular conveyor sections; and
a programmable circuit for dynamic scheduling of automatic labware handling operations.

2. An automatic labware handling system, comprising:
a stacker having a mechanism for pickup and release of said labware for storage;
a plurality of interchangeable conveyor sections having mechanical and electrical interface connections for allowing bi-directional movement of labware between a plurality of locations on the handling system;
a robotic positioning device for placing or removing objects on from said modular conveyor sections; and
a programmable circuit that includes a multitasking executable core program for dynamic scheduling and control of automatic labware handling operations.

3. The automatic labware handling system of claim 2 wherein the system communicates by serial commands.

4. The automatic labware handling system of claim 2 wherein the system communicates by dynamic data exchange.

5. The automatic labware handling system of claim 2 wherein the system communicates by Active X technologies.

6. The automatic labware handling system of claim 2 wherein the system communicates by small computer system interface.

7. The automatic labware handling system of claim 2 wherein the system communicates by relay control.

8. An automatic labware handling system, comprising:
a stacker having a mechanism for pickup and release of said labware for storage;
a plurality of interchangeable conveyor sections having mechanical and electrical interface connections for allowing bi-directional movement of labware between a plurality of locations on the handling system;
a robotic positioning device for placing or removing objects on from said modular conveyor sections; and
a programmable circuit including a multitasking executable core program and a VBA script for dynamic scheduling and control of automatic lab ware handling operations.

9. The automatic labware handling system of claim 8, further comprising a washer for rapidly rinsing plates with selected fluids.

10. The automatic labware handling system of claim 8, further comprising a dispenser for performing bulk pipetting.

11 The automatic labware handling system of claim 8, further comprising a sealer for automatically sealing microplates with a protective layer.

12 The automatic labware handling system of claim 8, further comprising a bar code labeler for applying bar codes to microplates.

13 The automatic labware handling system of claim 8, further comprising an incubator for providing environmental control for assays.

14 The automatic labware handling system of claim 8, further comprising an autosampler for injecting samples from microplates into analytical instruments.
